(19) United States
(12) Patent Application Publication
(10) Pub. No.: US 2016/0047687 A1
(43) Pub. Date: Feb. 18, 2016

(54) SELF-CALIBRATING ULTRASONIC-BASED MONITORING SYSTEM

(71) Applicant: THE UNIVERSITY OF WESTERN ONTARIO, London (CA)

(72) Inventors: Anand PRAKASH, London (CA); Abhishek SHUKLA, London (CA); Richard HONE, Ilderton (CA)

(21) Appl. No.: 14/779,077

(22) PCT Filed: Mar. 21, 2014
(86) PCT No.: PCT/CA2014/050301

§ 371 Date: Sep. 22, 2015

Related U.S. Application Data
(60) Provisional application No. 61/804,374, filed on Mar. 22, 2013.

(51) Int. Cl. G01F 25/00; G01F 23/296

(52) U.S. Cl. CPC G01F 25/0061; G01F 23/2962

(57) ABSTRACT

Systems, methods, and devices for determining distances inside a liquid filled container such as an oil tank. A combined ultrasonic signal receiver/transmitter with an attached reflector is immersed in the liquid. An ultrasonic signal is then transmitted from the receiver/transmitter and reflected ultrasonic signals are then received. One of the reflected signals is reflected off of the attached reflector and this reflected signal is then used to determine the signal's velocity and to thereby self-calibrate the system. Once the velocity in the liquid is known, the other reflected signals can then be used to determine the distance between the receiver/transmitter and at least one point of interest in the container.

### TECHNICAL FIELD

The present invention relates to liquid measurement devices. More specifically, the present invention relates to methods and devices for determining distances between interfaces in a liquid filled container.

### BACKGROUND OF THE INVENTION

Some examples of potential applications of the device include Oil-water separation in petroleum refinery operations such as crude oil desalting, discharge from electrical substations and waste oil/grease separation from the effluent of food processing installations. Crude oil desalter in petroleum refinery is used to remove dissolved salts in crude oil which can create several problems in downstream processing equipment due to corrosion contamination and other issues. The crude oil fed is mixed with wash water to dissolve out the salts. The oil and water mixture is then sent to a separator where an oil-water interface level is maintained to avoid any loss of washed oil or any ingress of water in oil stream. Thus a continuous monitoring of the interface level is critical for the desalter operation. In a number of food processing installations, waste water streams containing fats, oils and grease (FOG) are generated. These streams require treatment to separate out the FOG contaminants. If FOG is not separated at source, it can disrupt wastewater treatment plants and clog sewer lines, leading to flooding. These disruptions can be expensive for municipalities. In order to minimize such issues, most municipalities in North America have restrictions on the amount of FOG that can be discharged into the sewage system. This transfers responsibility for managing FOG to the source where it is generated.

Removal of FOG at the source is generally addressed by installing a grease interceptor. Most interceptors are passive devices that hold grease and require regular pumping to remove the grease they have collected. Pumping is an additional cost to the business owner but not pumping can lead to by-law violations and fines. So there is value in a device that can help the owner pump only when required.

In addition to the regulatory requirements, there is an economic incentive to manage FOG. There are now green technologies that can use such waste products as fuel for vehicles and other internal combustion engines. This means FOG can be an additional source of revenue for a business. Of course the most efficient way to make use of this waste oil is to collect it only when the interceptor is full, but not overfull and thus out of compliance with regulations.

In order to stay in compliance with regulations and to best manage FOG as a resource, business owners need to estimate the oil content in their interceptors.

Although there are several sensors available for oil level detection, their limitations have been identified based on field tests. A commonly used sensor for liquid level measurements is based on the capacitance and/or inductance principle. However its output is affected by changes in the liquid composition at the measurement location. Moreover, any fouling of the probe surface has a major adverse effect on the probe's performance and accuracy.

Another limitation of this technique is that it can only detect whether the oil-level is above or below a certain pre-fixed location where the sensor is mounted. For oil-layer thickness measurement, multiple capacitance probes need to be mounted at discrete intervals (segmented probes). However, this requirement increases the number of probes and power consumption, thereby leading to an increase in the initial cost of the device as well as maintenance and operation costs. An ultrasonic sensor developed by Greasewatch® (www.greasewatch.com) is an alternative to the capacitance based probes. The sensor consists of three ultrasonic transducers mounted at a preselected level. The first ultrasonic transducer measures the time-of flight of a signal reflected from an interface below the sensor and the second probe measures the interface above the sensor. The third probe is isolated in an air column and it provides a reference level. However, this design is prone to sensor fouling due to sediment settling on the upward facing transducer. Furthermore, the sensor measurement accuracy is adversely affected by continuously changing ambient conditions and presence/variations in suspended solids/impurities in the suspension. The sensor is also prone to ambiguities in measurement since it is incapable of detecting whether it is in the oil layer or the water layer. This approach is further limited by the requirement for the system to know the specific vessel dimensions and configuration, before calculating the fluid levels.

There is therefore a need for methods, systems, and devices that address the issues noted above. As well, it is preferred that such solutions mitigate if not overcome the shortcomings of the prior art.

### SUMMARY OF INVENTION

The present invention provides systems, methods, and devices for detecting presence of one or more interface and accurately determining the height of one desired layer inside a multi-phase liquid-filled container such as an oil separator tank. The present invention allows for accurate measurement of a desired liquid layer inside a container while the contents experience frequent variations in characteristics including composition, temperature, and the nature of the suspended particles. Such dynamic and contaminated environments can easily lead to loss of accuracy, signal scatter, probe fouling and other issues. The new device is a combined ultrasonic signal receiver/transmitter of selected centre frequency and bandwidth from the range of 0.1 MHz to 20 MHz. The device has an attached reflector which is immersed in the liquid. An ultrasonic signal is transmitted from the receiver/transmitter and reflected ultrasonic signals are then received. One of the reflected signals is reflected off of the attached reflector and this reflected signal is then used to determine the signal's velocity and to thereby self-calibrate the system. Once the velocity in the liquid is known, the other reflected signals can then be used to determine the distance between the receiver/transmitter and at least one point of interest in the container.

In a first aspect, the present invention provides a method for determining a distance from a signal receiver/transmitter to a point of interest in a container containing at least one type of liquid, the method comprising:

a) performing a self-calibration step to determine a velocity of an ultrasonic signal in said at least one type of liquid, said self-calibration step being performed using a receiver/transmitter immersed in said at least one type of liquid;
b) receiving reflected signals reflected from said point of interest, said reflected signals being received by said receiver/transmitter;
c) analyzing said reflected signals to determine which relevant reflected signals are from said point of interest; and
d) using said velocity determined in step a) and said relevant reflected signals to calculate said distance from said point of interest to said receiver/transmitter;
wherein said receiver/transmitter is immersed in said at least one type of liquid.

In a second aspect, the present invention provides a system for determining a distance between a receiver/transmitter assembly and a point of interest in a liquid filled container, the system comprising:
a receiver/transmitter assembly comprising:
   a signal transmitter for transmitting a signal through said liquid;
a signal receiver for receiving reflected signals;
   a reflector coupled to said transmitter/receiver at a predetermined distance from said receiver for reflecting a signal back to said receiver, said receiver and transmitter being adjacent to each other;
   a housing for containing said assembly;
a data processing module for receiving data from said receiver, said data processing module processing said data to determine a velocity of said signal through said liquid.

In a third aspect, the present invention provides A method for determining a distance from a signal transmitter/receiver to a point of interest in a container containing at least one type of liquid, the method comprising:

a) sending at least one ultrasonic signal from said receiver/transmitter into said at least one type of liquid, said receiver/transmitter being immersed in said at least one type of liquid;
b) receiving reflected signals resulting from said at least one ultrasonic signal;
c) analyzing said reflected signals to isolate specific expected reflected signals from expected sources;
d) determining a velocity of said at least one signal in said at least one type of liquid using at least one of said specific expected reflected signals isolated in step c); and
e) determining a distance from said signal transmitter/receiver to said point of interest using said velocity determined in step d) and said specific expected reflected signals isolated in step c).

In a fourth aspect, the present invention provides A device for use in determining a distance between a receiver and a point of interest in a liquid filled container, the device comprising:
said receiver for receiving a reflected signal;
a transmitter for transmitting a signal to be reflected back to said receiver, said transmitter being adjacent said receiver; and
a reflector positioned at a predetermined distance from said receiver;
   wherein
said device is immersed in liquid contained in said container when said device is in use.

The analysis used in the invention may use signal processing methods including conditioning, fast Fourier transform (FFT), frequency shift, attenuation and statistical analysis of previously received results, and comparisons of characteristics of reflected signals with characteristics of previously received reflected signals.

### BRIEF DESCRIPTION OF THE DRAWINGS

The embodiments of the present invention will now be described by reference to the following figures, in which identical reference numerals in different figures indicate identical elements and in which:

FIG. 1 is a block diagram of a system according to one aspect of the invention;

FIG. 2 is an illustration of a receiver/transmitter according to another aspect of the invention for use with the system illustrated in FIG. 1;

FIG. 3 is a sample waveform of reflected signals received by the receiver/transmitter;

FIG. 4 is a sample waveform after processing to isolate the strongest reflected signals; and

FIG. 5 is a flowchart detailing the steps in a method according to another aspect of the invention.

### DETAILED DESCRIPTION OF THE INVENTION

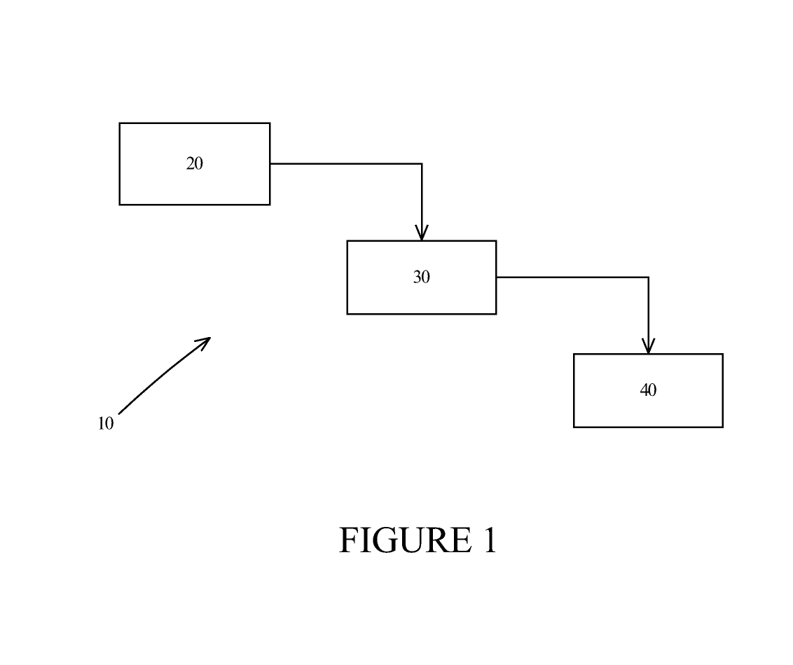

Referring to FIG. 1, a block diagram of a system according to one aspect of the invention is illustrated. The system 10 has a receiver/transmitter assembly 20, a data collection module 30, and a data processing module 40. When deployed, the receiver/transmitter assembly 20 is immersed at a predetermined and known depth in a container containing a liquid. The liquid may be a solution or a mixture of many types of liquids. In one implementation, the liquid has at least two different types of liquids, each of which is immiscible in the other. As an example, a water/oil mixture may be used, with the oil floating atop the water. For this example, the receiver/transmitter assembly 20 would be floating in the oil and can be used to determine the depth of the oil as well as to estimate the depth of the water in the container.

The receiver/transmitter assembly 20 may use a single combined receiver/transmitter or it may use a receiver separate from a transmitter. For a separate receiver and transmitter, the receiver should be adjacent to the transmitter. The receiver/transmitter assembly 20 also has a reflector mechanically attached to the receiver at a predetermined and known distance from the receiver. The reflector is attached to the receiver such that signals transmitted from the transmitter can be reflected off of the reflector back to the receiver.

To operate this aspect of the invention, the transmitter transmits a signal. The signal then reflects off of the reflector as well as off of possible points of interest within the container. As an example, the signal would be reflected off of a boundary between the oil layer and the water layer in the oil/water mixture discussed above.

It should be noted that in one implementation of the invention, ultrasonic signals are used. Such signals are suitable for travelling in a liquid medium as well as reflecting off of possible points of interest in the liquid or in the container. For this implementation of the invention, an ultrasonic transmitter is therefore used in conjunction with an ultrasonic receiver. Or, as noted above, a combined ultrasonic transmitter/receiver may be used.

The system illustrated in FIG. 1 operates with the transmitter first transmitting a signal. The transmitted signal is an ultrasonic signal of known and selected frequency, signal strength, and duration. This transmitted signal is then reflected off of all the possible points of interest as well as off of the reflector. These reflected signals are then all received by the receiver and sent to the data collection module. The data collected is then analyzed by the data processing module. The data processing module determines the strongest reflected signals and also determines the velocity of the signal through the liquid using the reflected signals. Once the velocity of the signal through the liquid is known, this can then be used, in conjunction with the other strong reflected signals, to determine the distance between the receiver and the point of interest which reflects the originally transmitted signal.

Regarding the ultrasonic signal, in one implementation, ultrasonic transducers with a bandwidth of 3.5 MHz and 1 MHz were found to be preferable. A planar, non-focussed, immersion quality transducer has been found to provide the best results. Other transducers with a center frequency of approximately 500 kHz to 5 MHz may also be used.

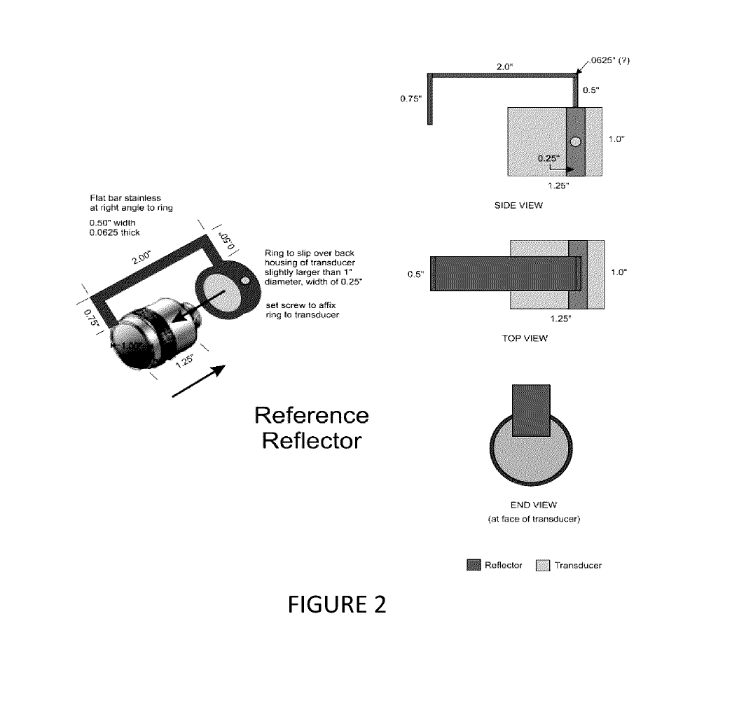

Referring to FIG. 2, an illustration of a receiver/transmitter according to one aspect of the invention is provided. FIG. 2 also shows different views of the receiver/transmitter assembly. As can be seen, part of the receiver/transmitter assembly is a ring configured reflector. The reflector is placed at a predetermined distance from the receiver/transmitter and is slightly offset from the main longitudinal axis of the receiver/transmitter. This offset is by design as a non-offset reflector may not let enough of the ultrasonic signal be transmitted to the rest of the liquid in the container. In one implementation, the distance between the transducer face and the face of the reflector was fixed at 50 mm based on tests under different conditions. The assembly allows a slip ring to fit tightly over the transducer housing, and to be locked in place with a set screw.

As noted above, the receiver/transmitter assembly is submerged in the liquid at a predetermined depth. This may be done by attaching the assembly to a float or a housing which suspends the assembly in the liquid such that the receiver/transmitter and the reflector are always submerged at a specific depth in the liquid.

The velocity of the signal in the liquid is determined by determining the time of flight for the signal to travel from the receiver/transmitter to the reflector and back to the receiver/transmitter. This calibration reflected signal is known to have only travelled the distance between the receiver and the reflector. Since the distance from the receiver/transmitter to the reflector is known and fixed, the calculation is a relatively simple one. The calculation for velocity is given in Equation (1):

$${v}_{ist} = \frac{Δ {d}_{Refl}}{{( TOF / 2 )}_{Refl}} \qquad ( 1 )$$

where:
vᵢₛₜ=signal velocity in the liquid
Δd_{Refl}=distance from receiver to reflector
(TOF/2)_{Refl}=half of time of flight of signal from transmitter to reflector to receiver

Once the signal's velocity in the liquid has been determined, this can be used to find the distance between the receiver and a point of interest. As noted before, this point of interest can be any feature in the container that the signal can reflect off of. Examples of such points of interest can be boundaries between different layers of different types of liquid in the container, accumulated solids at the bottom of the container, and the floor of the container.

To determine the distance (or height) of the top liquid layer in the container, the calculation used is as follows (Equation 2):

hₒᵢₗ(vᵢₛₜ)×(TOF/2)_{Intf} (2)

where
hₒᵢₗ=height of the top oil layer in an oil/water mixture in the container or the distance from the receiver to a point of interest
(TOF/2)_{Intf}=half of time of flight of signal from transmitter to point of interest to receiver

The above equation can also be used to determine the distance between the receiver and other points of interest.

To determine the time of flight or travel time mentioned in the equations above, the signals received by the receiver are analyzed. The reflected signals would have different width, height and location depending on points of reflection. However, once the reflected signals have been received, the waveform can be processed to filter out weaker signals. The remaining signals are analyzed using a matrix based algorithm which also calculates received signal width to height ratio and makes comparison with tabulated values in reference table.

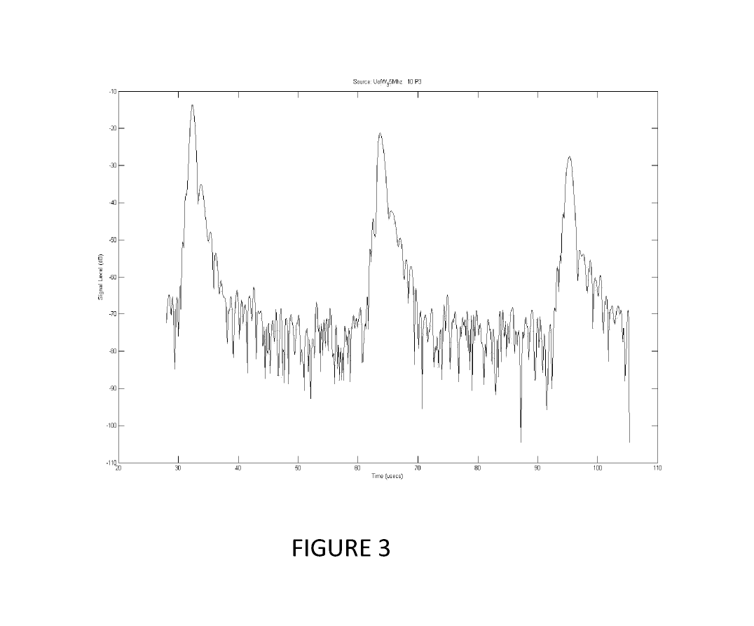

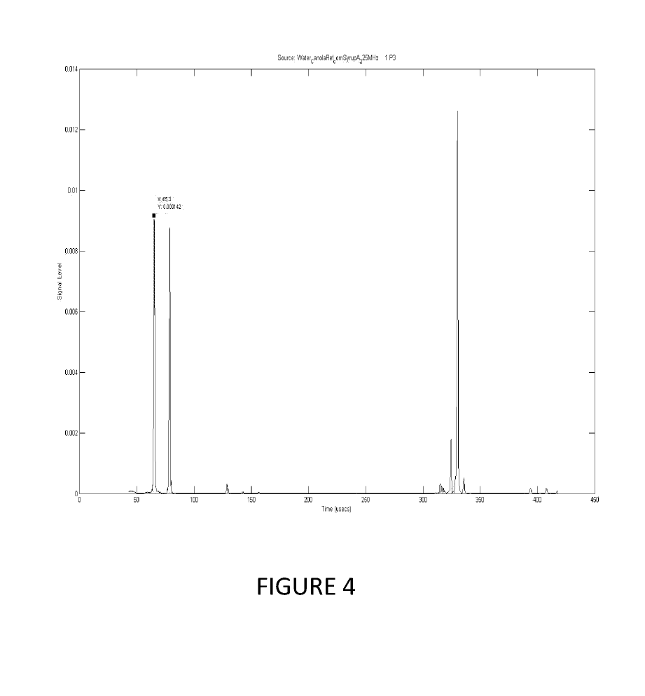

A sample of the waveform of reflected signals received by the receiver is shown in FIG. 3. As can be seen, there are 3 spikes or strong signals in the waveform. However, the seemingly noisy character of the waveform can be problematic when it comes to determining which reflected signals are of interest. FIG. 4 shows the result after the waveform has been suitably processed and filtered. As can be seen, processing the waveform removes or minimizes the noisy background signals and accentuates the stronger signals.

Referring to FIG. 4, it can be seen that the first strong reflected signal was received at 65 μsec after the ultrasonic signal was transmitted. Since the first reflected signal to be received is expected to be reflected from the reflector, then (TOF/2)_{Refl} should equal 32.5 μsec. The next strong signal was received at 79 μsec after the ultrasonic and, since the liquid used for these tests was a water/oil mixture, this strong signal can only come from the boundary between the oil layer and the water layer. The final strong signal at the right of the plot can only be either the bottom of the container or sludge accumulated at the bottom. Note that the waveforms in FIGS. 3 and 4 are for a test configuration. Other, more complicated waveforms are possible when the system is used with an oil/water mixture with particulates of differing sizes being suspended in the mixture.

The above should be seen as merely an example of the processing and analysis can be used to determine the distance between the receiver and the points of interest. Other, more complex processing and analysis steps can be used arrive at cleaner, less noisy results.

It should be noted that the determination of the signal's velocity within the liquid in the container is a self-calibration of the system. Instead of relying on lookup tables for signal velocities in differing temperatures, compositions of liquid, and other changing conditions, the system self-calibrates by determining what that velocity is for the current conditions when a measurement is made. The system therefore performs a self-calibration prior to determining the distances to the points of interest in the liquid in the container. As noted above, the velocity determined in this self-calibration is then used to determine the distance between the receiver and the point of interest reflecting the signal.

The data gathered by the system can be processed in multiple ways. However, it has been found that the waveforms of the reflected signals are best processed after they have been transformed into the frequency domain.

As can be seen by a comparison between FIGS. 3 and 4, peaks in the waveform (representing strong reflected signals) are easier to view and isolate in the frequency domain version of the reflected signals. At least some of these peaks represent reflected signals from points of interest. One challenge is to determine the source of the reflected signals that are represented by these peaks. Various methods, such as frequency content analysis, frequency pattern analysis, statistical analysis, and attenuation or energy loss analysis may be used to determine the source of the reflected signals.

In one embodiment of the invention, statistical analysis of the various peaks within a given time window in the waveform is used to rank the potential source of the different peaks. The ranking is then used to determine the source of the reflected signal. The statistical analysis of the signal such as time based averaging can help weed out signals from suspended particles, bubbles etc. any of which can act as scatterers.

In another embodiment of the invention, shifts in the peak frequency and in the attenuation associated with each frequency level are compared with a reference signal. The results can then be combined with the statistical analysis and ranking noted above.

The system may use attenuation-based methods to determine if more rigorous data processing and filtering is required.

The attenuation mechanism and extent of attenuation in an inhomogeneous medium is dependent on the physical properties of the liquid and solid phases along with particle size, pulse frequency and particles concentration. Different mechanisms of wave propagation are known (Shukla et al., 2010; Dukhin and Goetz, 2002) and can be broadly categorized under absorption (viscous and thermal losses) and scattering losses. The extent of these losses is a function of the wave propagation regimes, which are defined using the non-dimensional wave number (kr). The wave number is the ratio of particle radius to pulse wavelength and can be calculated using Equation 3 below. Different wave propagation regimes identified based on this number is also shown in the equation given below.

$$kr = \frac{ω}{c} r = \frac{2 π f}{c} r = \frac{2 π r}{λ} \\ kr << 1 ; λ >> r Long wave regime \\ kr ∼ 1 ; λ ∼ r Intermediate wave regime \\ kr >> 1 ; λ << r Short wave regime \qquad ( 3 )$$

Impurities of different types can affect loss mechanism in different ways and generate interfering signals which can give rise to erroneous results. An attenuation coefficient (a) of the pulse calculated using Equation 4 below may be used for comparison and ranking.

$$α = \frac{1}{d} ln ( \frac{{A}_{O}}{{A}_{R}} ) \qquad ( 4 )$$

In the above equation A₀ and A_{R} refer to amplitudes of the generated and received signals and d is the distance between transmitter and receiver. For ease of use, reference values of attenuation coefficients can be measured and stored for comparison. In a typical application, a significant change in attenuation coefficient from a reference value can be attributed to viscous dissipations or scattering losses. In order to determine the prevailing mechanism, the frequency domain versions of the reflected signals are used to determine frequency patterns and are compared with reference signals. A significant shift in peak frequency between the reference signals and the received results indicates the presence of larger particles in the suspension and a resulting need to for filtering and more rigorous statistical analysis. If there is no shift in peak frequency filtering may not be required and only statistical analysis could suffice.

The data gathered can also be used to determine if the system is malfunctioning. As an example, for a floating embodiment of the invention, if the results received show that the reflected signals are travelling through air, then the receiver/transmitter may be pointing up and, as such, other contingencies may need to be taken. Similarly, if the results indicate that there is no boundary layer (i.e. no points of interest were found), then the oil tank under consideration may only have water left inside. But, if the results show that there are points of interests being encountered by the ultrasonic signal, then the system can proceed with determining the distance to these points of interest.

A note should be made about the reflector as positioned in the oil/water mixture. If a user desires to know the height of the top layer in an oil/water mixture, the distance from the top of liquid to the face of the transducer may need to be known in order to add that displacement/distance to the total liquid (or oil) column height.

If a user wished to find the height of sludge at the bottom of the liquid filled container, perhaps filled with an oil/water mixture, the system noted above can determine this distance. The system will pick up reflected signals from the sludge at the bottom of the container. However, if the liquid is still an oil/water mixture, these reflected signals will be weak, especially when the oil layer height is high. However, after the oil is pumped out, the receiver/transmitter assembly will be mostly in water and can thus properly record a suitable corresponding velocity. Moreover, the reflected signal from top of sludge will be stronger thus providing a more accurate reading of settled sludge level in the container.

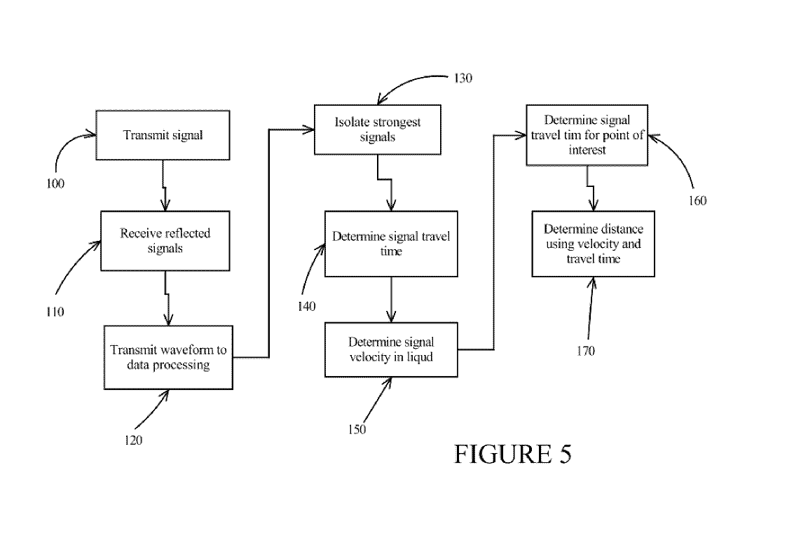

Referring to FIG. 5, a flowchart illustrating the steps in a method according to one aspect of the invention is presented.

The method begins at step 100, that of transmitting a signal through the liquid in the container. The signal can be, as explained above, ultrasonic or it can be other signals which easily propagates through various types of liquid. The signal is transmitted through the liquid and is reflected back to the receiver/transmitter by the reflector and possible points of interest in the liquid and in the container. Step 110 is therefore that of receiving reflected signals at the receiver.

Once the reflected signals have been received at the receiver, the signals are then turned into a waveform which be analyzed and processed. The waveform is then transmitted to the data processing module (Step 120).

The waveform processing then isolates the strongest reflected signals (step 130) and determines their travel time or time of flight to reach the receiver (step 140). The travel time can be found using the time of arrival and, with the travel time, the velocity of the signal through the liquid is then calculated (step 150). As an optional step, the velocity calculated in step 150 can be compared with a range of expected velocity values. If the velocity calculated is outside the expected range, an alarm can be triggered as this could mean that there is something wrong in the system. Further error tracking and checking steps can then be taken.

The next step in the process is that of determining when a reflected signal from a point of interest is received by the receiver. The time of flight for the reflected signal is determined (step 160) and the distance between the point of interest and the receiver is calculated using the velocity found in step 150 (step 170).

It should be noted that while the above discusses a combined receiver/transmitter assembly with a single transducer acting as the receiver/transmitter, other embodiments are possible. As an example, instead of a single combined receiver/transmitter, a separate receiver and a separate transmitter can be used. Of course, for this configuration, the receiver and transmitter would have to be quite close or adjacent to one another for the calculations above to work.

The method steps of the invention may be embodied in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system which is provided with means for executing these steps. Similarly, an electronic memory means such computer diskettes, CD-Roms, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language For example, preferred embodiments may be implemented in a procedural programming language (e.g. “C”) or an object oriented language (e.g. “C++”, “java”, or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

1. A method for determining a distance from a signal receiver/transmitter to a point of interest in a container containing at least one type of liquid, the method comprising:
a) performing a self-calibration step to determine a velocity of an ultrasonic signal in said at least one type of liquid, said self-calibration step being performed using a receiver/transmitter immersed in said at least one type of liquid;
b) receiving reflected signals reflected from said point of interest, said reflected signals being received by said receiver/transmitter;
c) analyzing said reflected signals to determine which relevant reflected signals are from said point of interest; and
d) using said velocity determined in step a) and said relevant reflected signals to calculate said distance from said point of interest to said receiver/transmitter;
wherein said receiver/transmitter is immersed in said at least one type of liquid.

2. A method according to claim 1 wherein said self-calibration step comprises:
transmitting said ultrasonic signal into said liquid;
receiving a calibration reflected signal, said calibration reflected signal being an ultrasonic signal reflected off of a reflected positioned at a predetermined distance from said receiver/transmitter;
determining a time of travel for said calibration reflected signal; and
using said time of travel and said predetermined distance to calculate said velocity.

3. A method according to claim 1 further including a step of determining if said at least one ultrasonic signal travels through a desired medium.

4. A method according to claim 3 wherein in the event said at least one ultrasonic signal travels through an undesired medium, an error alert is generated.

5. A method according to claim 1 wherein statistical analysis is used to rank potential sources of said reflected signals.

6. A method according to claim 1 wherein step c) comprises analyzing characteristics of said reflected signal, said characteristics including at least one of:
attenuation;
energy loss;
frequency content; and
frequency patterns.

7. A method according to claim 1 wherein said at least one point of interest is a boundary layer between two liquids which are immiscible with one another.

8. A method according to claim 1 wherein said at least one point of interest comprises at least one solid contained in said container.

9. (canceled)

10. (canceled)

11. (canceled)

12. (canceled)

13. (canceled)

14. (canceled)

15. (canceled)

16. (canceled)

17. A system for determining a distance between a receiver/transmitter assembly and a point of interest in a liquid filled container, the system comprising:
a receiver/transmitter assembly comprising:
a signal receiver for receiving reflected signals;
a signal transmitter for transmitting a signal through said liquid;
a reflector coupled to said receiver at a predetermined distance from said receiver for reflecting a signal back to said receiver, said receiver and transmitter being adjacent to each other;
a housing for containing said assembly;
a data processing module for receiving data from said receiver, said data processing module processing said data to determine a velocity of said signal through said liquid.

18. A system according to claim 17 wherein said data processing module executes a method for determining a distance from said signal transmitter/receiver to said point of interest, the method comprising:
a) sending at least one signal from said transmitter into said liquid;
b) receiving reflected signals resulting from said at least one signal using said receiver;
c) analyzing said reflected signals to isolate specific reflected signals from expected sources;
d) determining a velocity of said at least one signal in said liquid using said specific reflected signals isolated in step c); and
e) determining a distance from said receiver to said point of interest using said velocity determined in step d) and said specific reflected signals isolated in step c).

19. A system according to claim 18 wherein step c) comprises using statistical analysis of previously received results.

20. A system according to claim 18 wherein step c) comprises comparing characteristics of said reflected signals with characteristics of previously received reflected signals.

21. A system according to claim 20 wherein said characteristics include at least one of:
attenuation;
energy loss;
frequency content; and
frequency patterns.

22. A system according to claim 18 wherein said statistical analysis is used to rank potential sources of said reflected signals.

23. A system according to claim 18 wherein said at least one signal is an ultrasonic signal.

24. A system according to claim 18 wherein said housing is buoyant in said liquid.

25. A system according to claim 18 wherein said housing is constructed and arranged such that said receiver and said transmitter are immersed in said liquid when said system is in use.

26. A device for use in determining a distance between a receiver and a point of interest in a liquid filled container, the device comprising:
said receiver for receiving a reflected signal;
a transmitter for transmitting a signal to be reflected back to said receiver, said transmitter being adjacent said receiver; and
a reflector positioned at a predetermined distance from said receiver;
wherein
said device is immersed in liquid contained in said container when said device is in use.
